(19) United States
(12) Patent Application Publication
(10) Pub. No.: US 2010/0314814 A1
(43) Pub. Date: Dec. 16, 2010

(54) Compressible Corralling Utensil with Cutting Board

(76) Inventor: Eric S. Zeitlin, Baldwin, NY (US)

Correspondence Address: Eric Zeitlin, 3059 Grand Avenue, Baldwin, NY, 11510, US

(21) Appl. No.: 12/794,751

(22) Filed: Jun. 6, 2010

Related U.S. Application Data
(60) Provisional application No. 61/268,214, filed on Jun. 10, 2009.

(51) Int. Cl. A47J 47/00; A47J 43/28

(52) U.S. Cl. 269/14; 15/236.07; 269/290

(57) ABSTRACT

A corralling utensil with associated cutting board (10). The corralling utensil (40) quickly, easily and accurately gathers and moves food or other items around and off the cutting board (20) to another location, and may be used separately from the cutting board (20) on other surfaces such as tables, counters, butcher blocks and chopping mats. The corralling utensil (40) may be rotated and/or change shape to facilitate better focusing of cut food into small containers. The corralling utensil (40) may be removably stored in, on, or to a designated area of the associated cutting board (20) for convenient storage and use.

### THIS APPLICATION CLAIMS PRIORITY FROM PROVISIONAL PATENT APPLICATION No. 61/268,214 Confirmation #7018 Date Filed: Jun. 10, 2009

### APPLICATION NUMBER

Provisional Pat. App. No. 61/268,214

### CONFIRMATION NUMBER

7018

### CROSS REFERENCE TO RELATED APPLICATIONS

U.S. Ser. No. 61/268,214

### FEDERALLY SPONSORED RESEARCH

N/A

### SEQUENCE LISTING OR PROGRAM

N/A

### BACKGROUND OF THE INVENTION

1. Field OF INVENTION

The present invention relates in general to kitchen utensils, and more specifically to a compressible corralling utensil with an associated cutting board in which the corralling utensil may be removably stored. The corralling utensil is used to quickly, easily and accurately gather and move food or other items around and off the cutting board or other surface, and may be rotated and/or compressed by the user for more accuracy.

2. Prior Art

After cutting food into smaller pieces on a cutting board, the cut food is typically moved around and off of the board into a container, such as a cooking pot, storage container, or dish. Often a kitchen knife is used to move the food. However, as a pile of cut food is pushed with the blade, pieces of food dissipate along the flat blade instead of staying in a complete pile. Additionally, blade edges are typically curved, making it unsuitable for effective scraping of a flat cutting board, necessitating multiple scraping movements in multiple directions to effectively move cut food with the knife, with some of the food ending up where it is not desired, for example on a table, countertop, stove, and floor, resulting in wasted food, time, and effort.

There are several products that address this problem. Some are scoops that carry cut food to a container, for example U.S. Pat. No. 6,733,056, to Daniele. However, they require the user to scrape food into the device, and often require scraping of the inside of the scoop to remove food remnants stuck inside it. A similar product is the Crumb Scraper, which waiters use to remove crumbs from tables; the present inventor is unaware of it being used in conjunction with a cutting board. Japanese patent publication JP2006130278 to Shunichi describes a squeegee that is attached to a kitchen knife to move cut vegetables. Unfortunately, this device must be attached to the kitchen knife before use, it may fall off the knife during use, and it will likely get in the way of cutting food. US Patent Application # 20090223060 to Zeitlin shows a removably attachable accessory for a kitchen knife for guiding piles of cut food around and off a cutting board which also must be attached to a kitchen knife before use.

Other products attempt to solve the problem by creating an area on or within a cutting board for funneling cut food into a container, by providing walls around the board or providing means for folding the board. An example of the former is U.S. Pat. No. 4,446,051 to Price. An example of the latter is U.S. Pat. No. 5,203,548 to Sanders. Unfortunately, not all of the cut food on these boards will fall off the board by the force of gravity only; the remainder still needs to be removed from the board, which may be difficult to do with these designs. In the case of walls surrounding the surface of a board, as in Price, the blade of a large kitchen knife may not fit within the area between the walls. In the case of folding boards, such as Sanders, it may be difficult for the user to hold the board unfolded with only one hand, while the other scrapes the board with the edge of their knife blade. Either way, a knife or other scraping device may be necessary to complete the process, with the resulting problems mentioned above.

U.S. Pat. No. D440,462 to Paschal, et al, shows a cutting board with what appears to be a sliding food pusher and removable measuring cup. It appears to work by the user pushing forward on the sliding food pusher to move cut food along the board into the measuring cup, which is pulled out for use. There are several drawbacks to this design. First, several things could cause the pusher to bind and not slide smoothly: Food may get caught between the pusher and the board during use, the board may shrink, expand, warp, or twist over time, and the user may not push forward evenly on the middle of the pusher. Further, only the top side of the board can be used for cutting, and any food that ends up in the grooves will not be pushed off the board. Additionally, the user may need to put their fingers at the front of the sliding pusher in order to grasp it, thereby contacting the food being pushed. Also, because the pusher can only move straight forward, the user must push food off the board at the front end of the board only, but some users prefer to push food off the sides of their boards. Another disadvantage of the pusher being confined to a straight path is that it does not provide means for the user to control the movement of food; if there is a large pile of food on the board, some of it may inadvertently dissipate along the length of the pusher and fall off the sides of the board as the pusher is slid forward, since the pusher cannot be rotated to focus the cut food into a container. In other words, the user is limited in their ability to accurately guide the food. Finally, the user does not have the option of moving only part of a pile of food, or only one pile when there is more than one on the board.

Lastly, U.S. Patent Application # 20090260168 by Zeitlin shows a Corralling Utensil with Associated Cutting Board that is similar to the present invention, including the ability to be squeezed to facilitate easier and more accurate scraping of food into a pot, however the corraller shown does not have a living hinge or similar facilitating means to make it easier to change the shape of the retaining wall, nor does it have a protrusion in its groove for facilitating the securing of its corralling utensil to its cutting board.

### BACKGROUND OF THE INVENTION

### Objects and Advantages

Accordingly, several objects and advantages of the present invention are:
(a) to provide a corralling utensil that facilitates faster, easier, and cleaner food preparation by providing means for more efficient and accurate gathering and moving of cut food around and off a cutting board or other surface, helping to prevent food from inadvertently falling off the board, and providing means for getting food into a small container by allowing the user to rotate and/or compress the corralling utensil to more accurately focus the food while moving it into the container;
(b) to provide a corralling utensil that allows the user to push food off any part of a cutting board, allows them to move part of a pile of food or a single pile when more than one is on the board, and helps keep their hands and fingers clean;
(c) to provide a cutting board with means for removably storing the corralling utensil, whereby fast and convenient access to the corralling utensil during food preparation is provided, the utensil is less likely to get lost or misplaced, and users can maintain their present cutting method and style.

Further objects and advantages will become apparent from a consideration of the ensuing description and drawings.

### SUMMARY

In accordance with the present invention, a compressible corralling utensil comprising a retaining wall with means for holding and moving the retaining wall is provided, along with an associated cutting board with means for the removable storage of the corralling utensil. The corralling utensil is used to quickly, easily and accurately gather and move food around and off the cutting board and other surfaces. Various embodiments are presented showing some of the many configurations the compressible corralling utensil and associated cutting board may take while maintaining the spirit of the present invention.

### DRAWINGS

### Figures

A more complete understanding of the method and apparatus of the present invention may be acquired by reference to the following Detailed Description when taken in conjunction with the accompanying Drawings wherein:

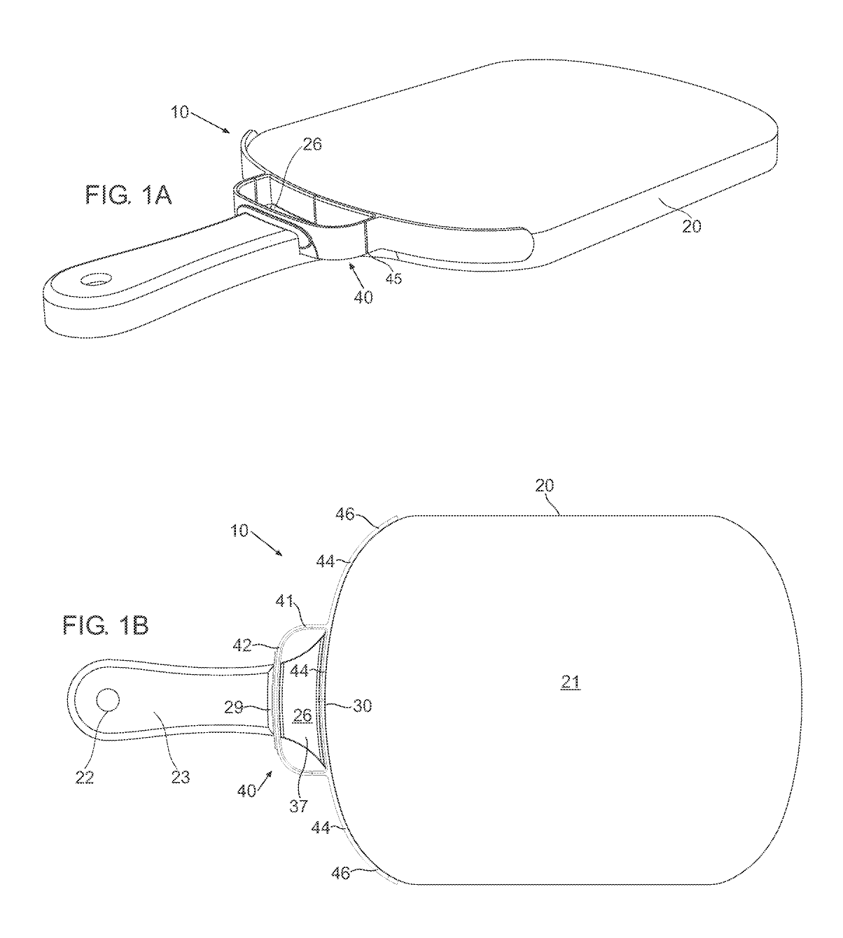

FIG. 1A is an illustration of the corralling utensil removably stored in the groove of the associated cutting board, in accordance with the present invention.

FIG. 1B shows a top view of the corralling utensil stored in the cutting board.

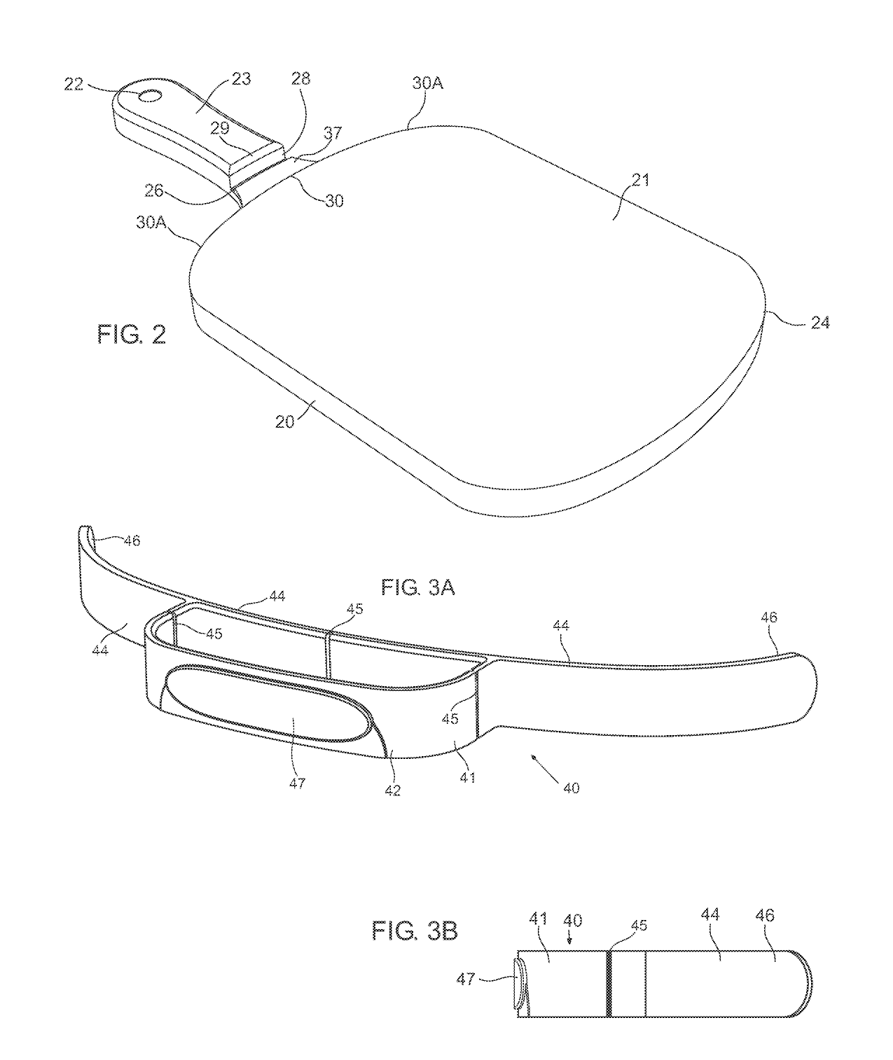

FIG. 2 shows a perspective view of the preferred embodiment of the cutting board.

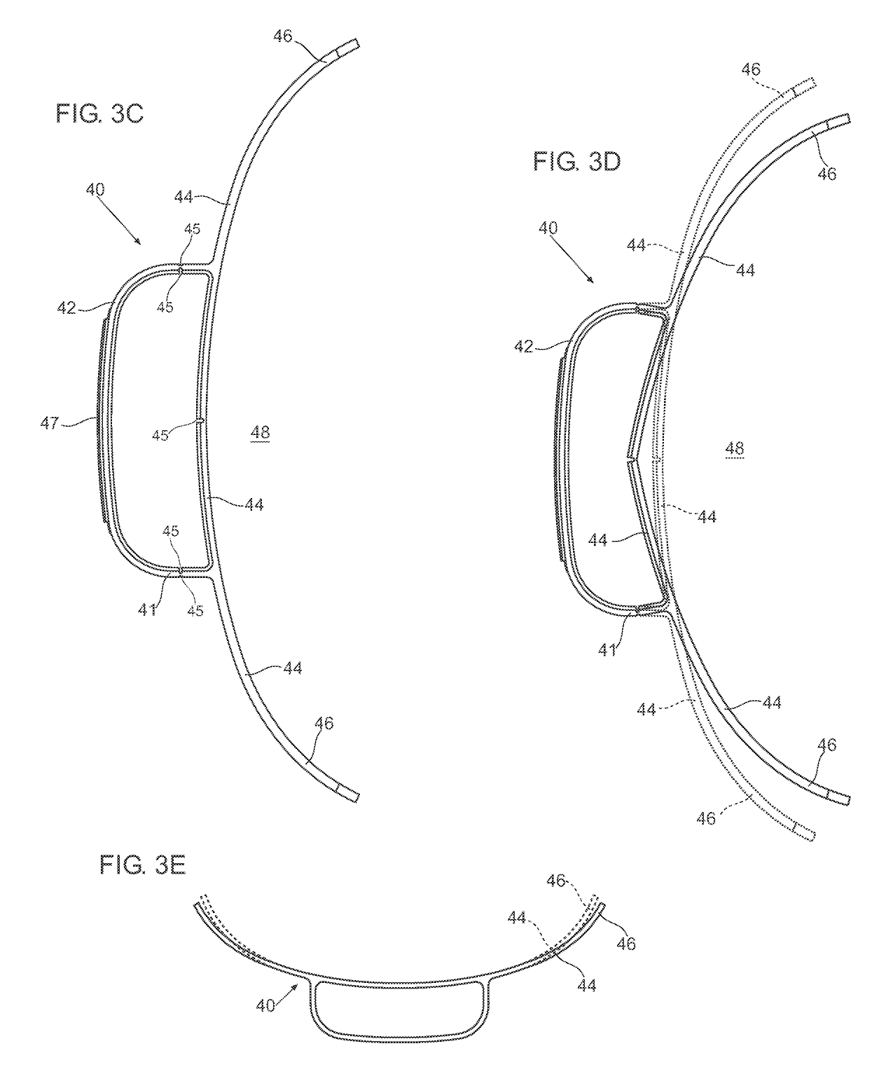

FIG. 3A shows a perspective view of the preferred embodiment of the corralling utensil of the present invention.

FIG. 3B shows a side view of the corralling utensil.

FIG. 3C shows a top view of the corralling utensil.

FIG. 3D shows a top view of the corralling utensil, illustrating arms (46) compressing forwards for more accurate guiding of food.

FIG. 3E shows a top view of the corralling utensil, illustrating arms (46) bending backwards for storage in the cutting board.

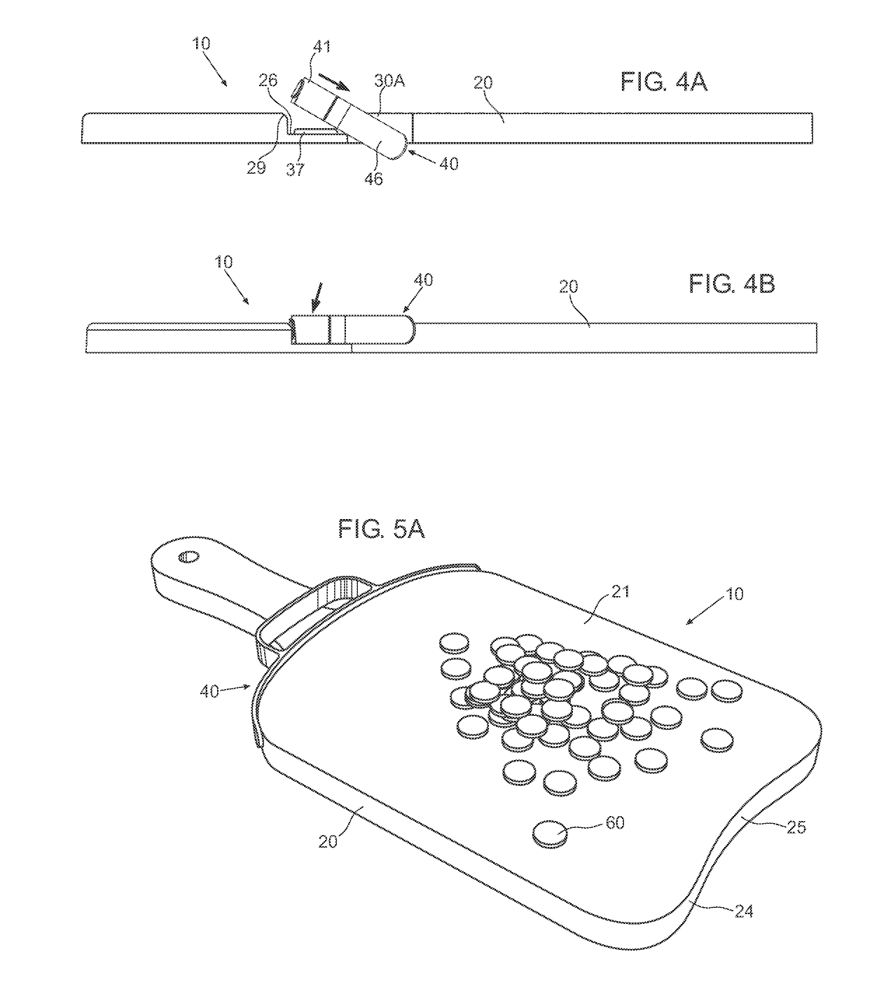

FIG. 4A shows a side view of the present invention, illustrating the corralling utensil being inserted into the groove of the cutting board.

FIG. 4B shows a side view of the present invention, illustrating the corralling utensil removably secured in the groove of the cutting board.

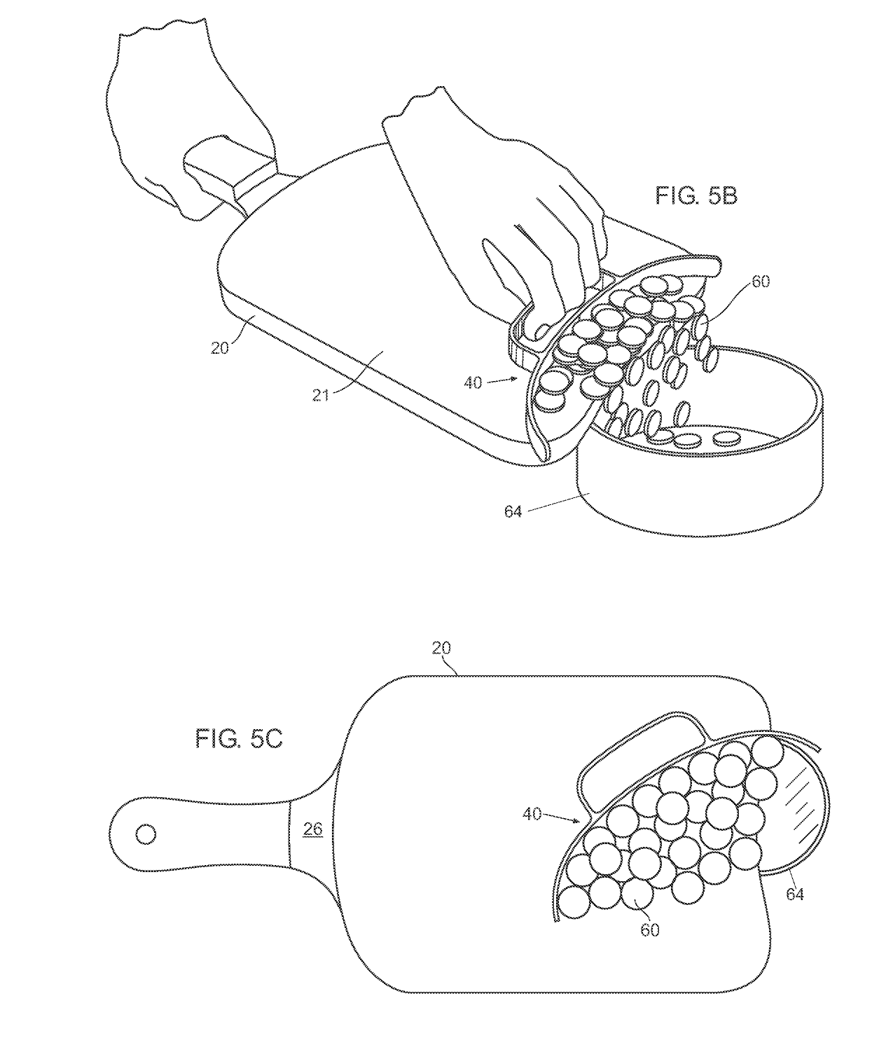

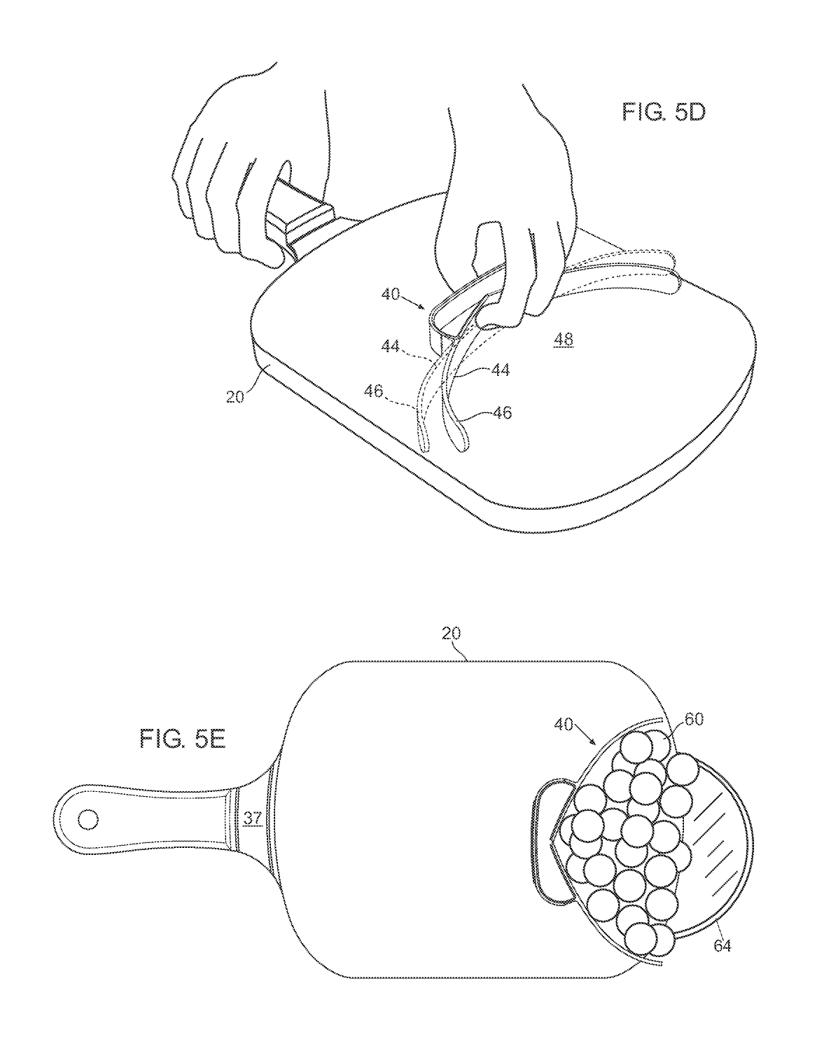

FIG. 5A shows the present invention with cut food on he cutting board.

FIG. 5B shows the present invention in use, with the corralling utensil being used to gather and move cut food off of the cutting board, into a container.

FIG. 5C shows a top view of the corralling utensil rotated while moving forward, illustrating how a user can focus food into a small container.

FIG. 5D shows a perspective view of the corralling utensil being compressed while moving forward, illustrating another method of how a user can focus food into a small container.

FIG. 5E shows a top view of the corralling utensil being compressed while moving cut food (60) forward, illustrating the focusing of food into a small container (64).

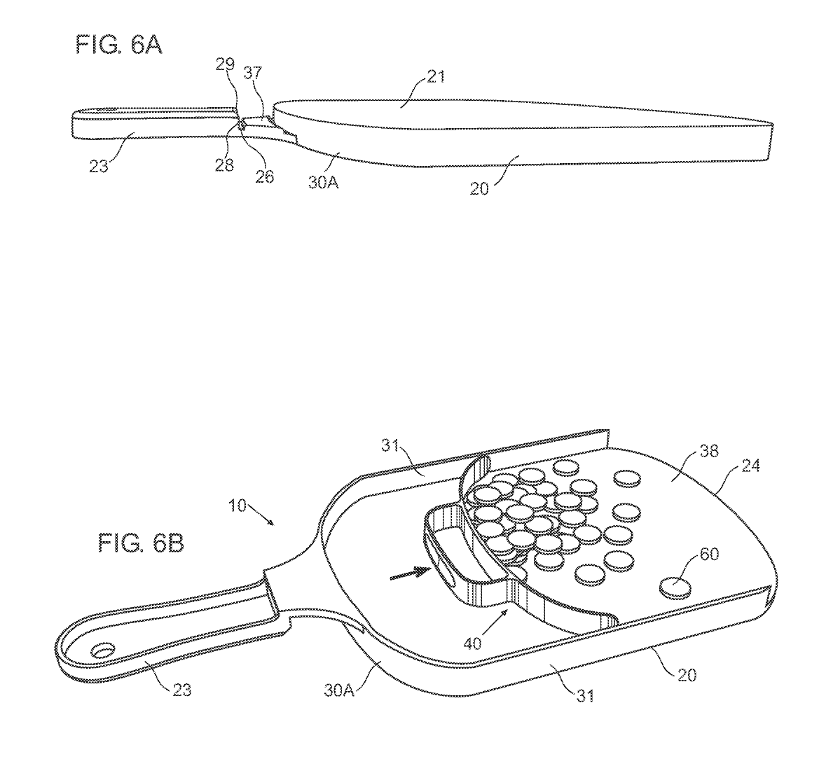

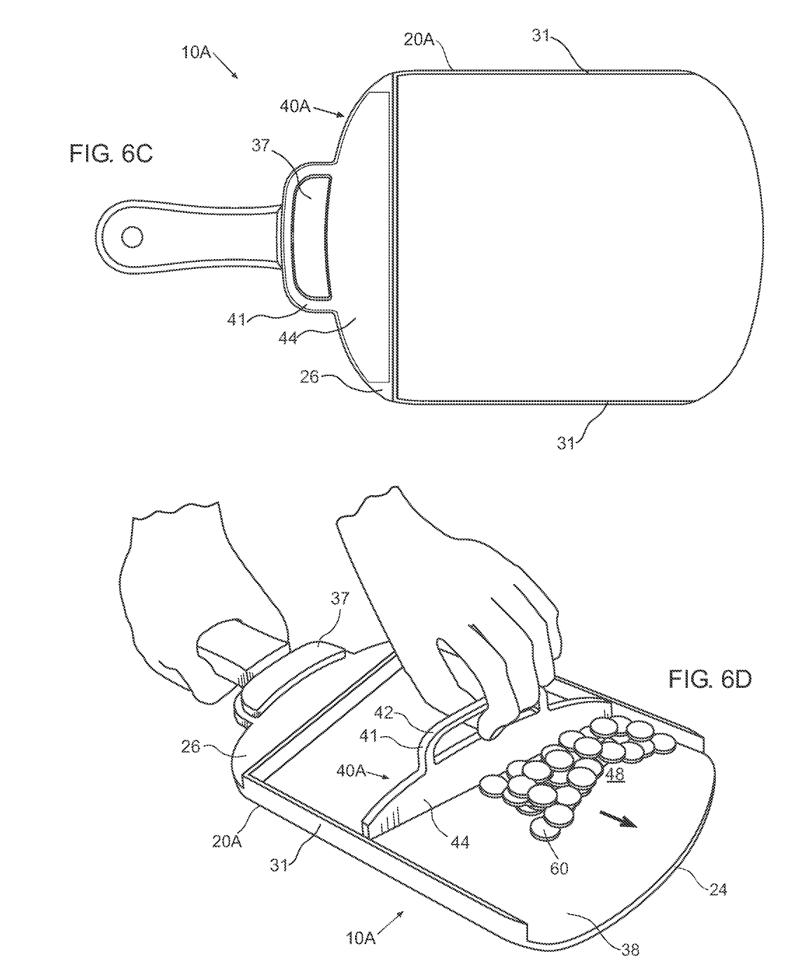

FIG. 6A shows an front perspective view of the cutting board of the present invention.

FIG. 6B shows a bottom perspective view of an injection molded version 20 of the cutting board of the present invention, showing the bottom cutting surface in use.

FIG. 6C shows a top view of an alternate version 10A of the present invention, showing cutting board 20A with a differently shaped flat corralling utensil 40A.

FIG. 6D shows a perspective view of alternate version 10A of the present invention, showing cutting board 20A in use with corralling utensil 40A.

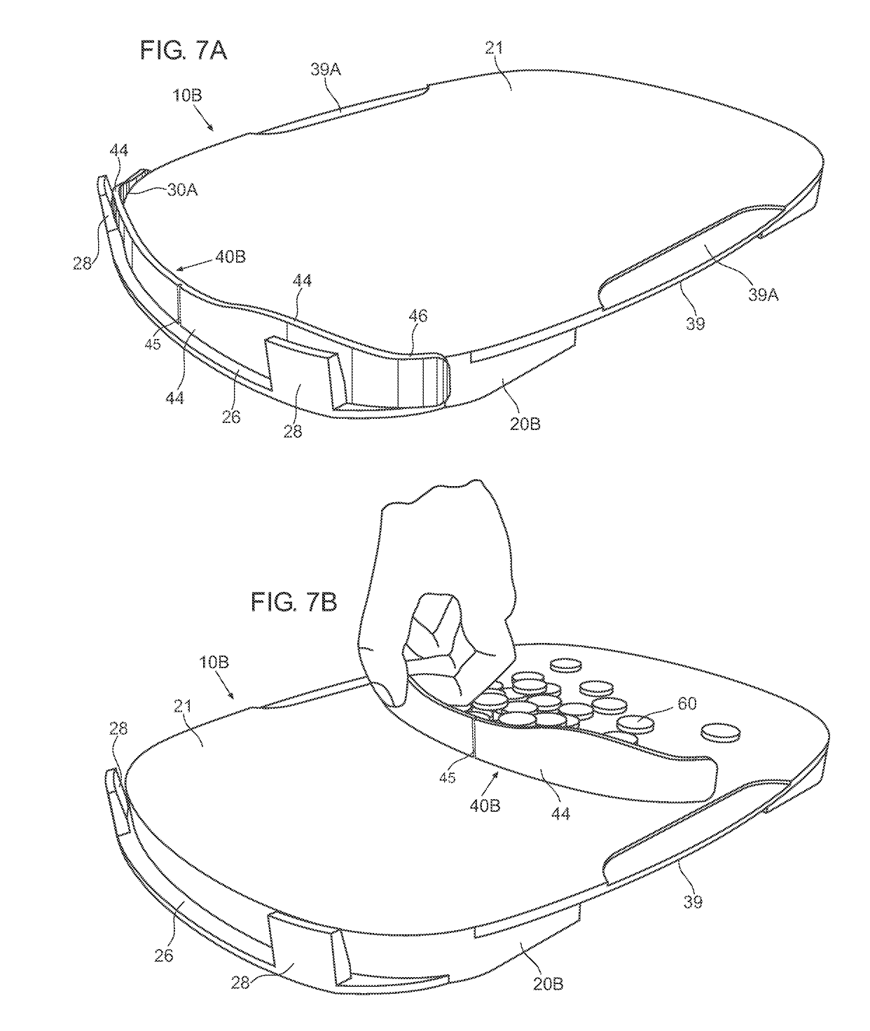

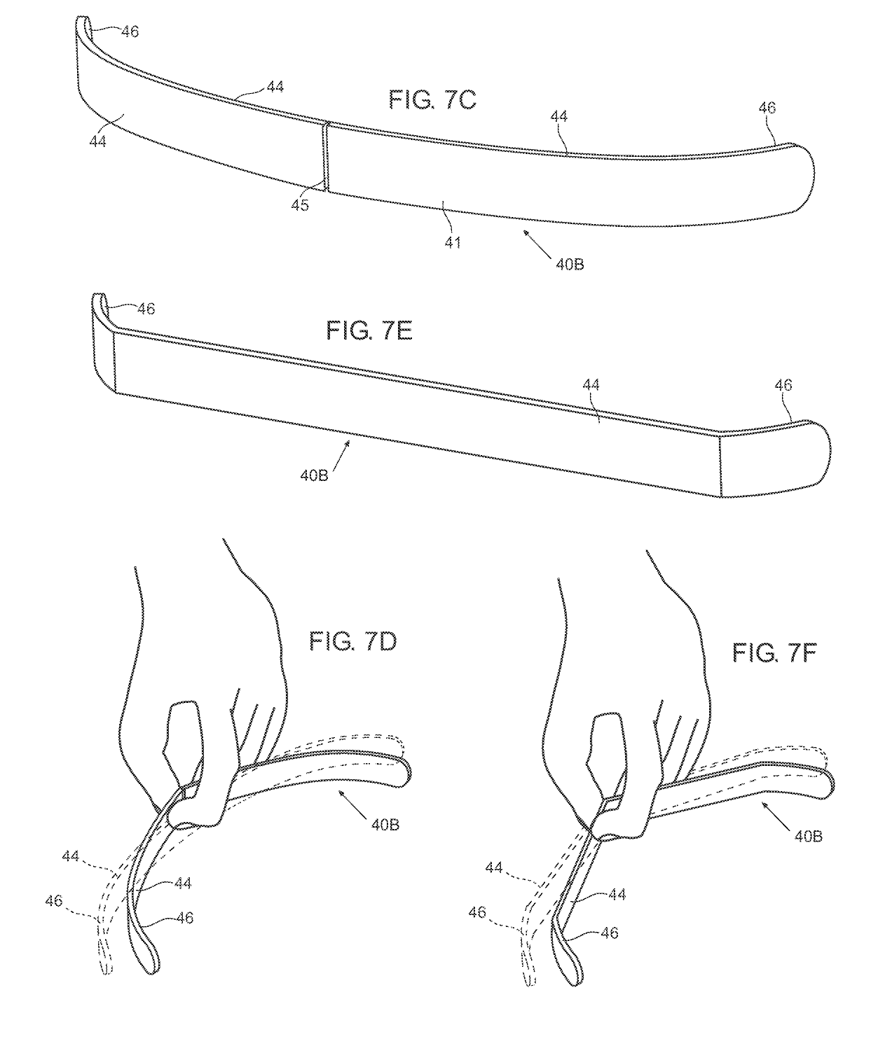

FIG. 7A shows a perspective view of alternative embodiment 10B of the present invention.

FIG. 7B shows a perspective view of alternative embodiment 10B of the present invention, with alternative corralling utensil 40B being used to corral food.

FIG. 7C shows a front perspective view of an alternative corralling utensil 40B of alternative embodiment 10B of the present invention.

FIG. 7D shows a front perspective view of an alternative corralling utensil 40B of alternative embodiment 10B of the present invention being compressed by the user.

FIG. 7E shows a front perspective view of an alternative corralling utensil 40B of alternative embodiment 10B of the present invention.

FIG. 7F shows a front perspective view of an alternative corralling utensil 40B of alternative embodiment 10B of the present invention being compressed by the user.

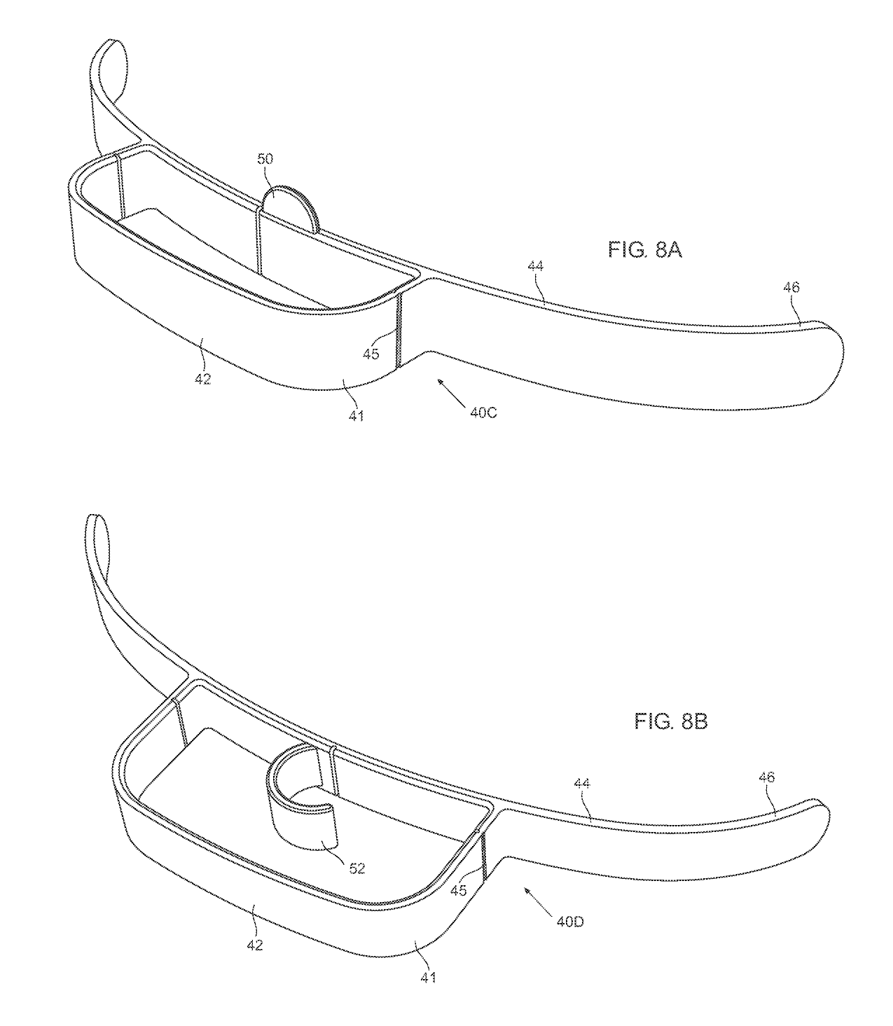

FIG. 8A shows a perspective view of an alternate corralling utensil 40C of the present invention.

FIG. 8B shows a perspective view of an alternate corralling utensil 40D of the present invention.

### DRAWINGS

### Reference Numerals

10—Corralling Utensil with Associated Cutting Board
10A—Alternative Embodiment A
10B—Alternative Embodiment B
10C—Alternative Embodiment C
20—Cutting Board
20A—Alternative Cutting Board A
20B—Alternative Cutting Board B
20C—Alternative Cutting Board C
21—Cutting Surface
22—Hanging Hole
23—Handhold for Cutting Board
24—Front End of Cutting Board
25—Front End Cutout
26—Groove for Storage of Corralling Utensil 40
28—Back Groove Wall
29—Rounded Top Edge of Back Groove Wall 28
30—Front Groove Wall
30A—Outer Front Groove Wall
31—Outer Board Wall
37—Raised Groove Protrusion
38—Recessed Bottom Cutting Surface
39—Gripping Recess
39A—Thumb Groove over Gripping Recess 39
40—Corralling Utensil
40A—Corralling Utensil of Alternative Embodiment A
40B—Corralling Utensil of Alternative Embodiment B
40C—Corralling Utensil of Alternative Embodiment C
40D—Corralling Utensil of Alternative Embodiment D
40E—Corralling Utensil of Alternative Embodiment E
41—Handle of Corralling Utensil
42—Handgrip of Handle 41
44—Retaining Wall of Corralling Utensil
45—Hinge
46—Arms of Retaining Wall 44
47—Protuberance on Handgrip 42
48—Gathering Area
50—Compression Protrusion
52—Finger Pull
60—Cut Food
64—Container

### DETAILED DESCRIPTION

### Preferred Embodiment—FIGS. 1A-6B

With reference now to the drawings, and in particular to FIGS. 1A-8B thereof, a novel corralling utensil with associated cutting board embodying the principles and concepts of the present invention and generally designated by the reference numeral 10 will be described. While the embodiments described herein are intended as an exemplary compressible corralling utensil with associated cutting board for cutting, gathering, and transferring food articles, it will be appreciated by those skilled in the art that the present invention is not limited to food articles, and may be employed for use with other items.

Referring now to FIGS. 1A-6B, a first embodiment of the present invention will be described in detail. FIG. 1A shows a perspective view of the Compressible Corralling Utensil with Cutting Board 10, with corralling utensil 40 inserted and removably secured in groove 26 of cutting board 20, while FIG. 1B shows a top view of same, illustrating how corralling utensil 40 nests within groove 26.

Cutting board 20 of the present invention is shown in FIG. 2 comprised of a cutting surface 21 and a handhold 23 with optional hanging hole 22 for hanging the board on a wall or other surface when not in use. Cutting surface 21 may be mostly flat, or curved, or have sections of both. Board 20 has a groove 26 formed therein, for removably receiving and accommodating corralling utensil 40. Groove 26 is one of many means to removably secure corralling utensil 40 to cutting board 20, and may take many different shapes, sizes, depths, and configurations. Groove 26 is delimited by back groove wall 28 and front groove wall 30. The top edge of back groove wall 28 is horizontally concave so that it generally matches the horizontally convex curve of the handgrip 42 of corralling utensil 40, as can be seen in FIG. 1B, but may be shaped differently to accommodate different designs of corralling utensil 40. Back groove wall 28 has an optional rounded top edge 29 which facilitates easier insertion and removal of corralling utensil 40 into groove 26. Back groove wall 28 may alternatively be chamfered. Front groove wall 30 is mostly convex, to generally match the horizontally concave curve of the retaining wall 44 of corralling utensil 40. The depth of groove 26 may vary, but should not be so deep as to compromise the integrity of board 20. Groove 26 may extend to encompass the surface area of the entire corralling utensil 40, it may be larger than the surface area of the entire corralling utensil 40, and may have walls protruding upwards from its sides or its entire perimeter. The front end 24 of board 20 may be shaped in various configurations, for example it may be straight, angled, curved, convex, etc. FIG. 5A shows front end 24 having a concave cutout 25 which may facilitate more accuracy in moving food off the front end 24 into a container. Similarly, one or both sides of board 20 may have a concave or convex section. The distance between the outer surface of handgrip 42 and the outer surface of retaining wall 44 is less than the distance between back groove wall 28 and front groove wall 30, to allow the insertion of corralling utensil 40 into groove 26, even if there are food remnants remaining on retaining wall 44.

Optional raised groove protrusion 37 rises mostly vertically out of groove 26 and serves several purposes. It helps keep corralling utensil 40 securely in place within groove 26, and it also assists the user in placing corralling utensil 40 within groove 26 by helping to self-center corralling utensil 40 within groove 26. Groove protrusion 37 is shaped so that it rises upwards to fit into the inner space of the handle of corralling utensil 40 between the back side of retaining wall 44 and the front side of handgrip 42, as shown in FIGS. 1B, 2, 4A, and 6C. This design facilitates retaining wall 44 sliding into the gap created between the front of groove protrusion 37 and front groove wall 30, while the handgrip 42 slides into the gap created between the back of groove protrusion 37 and back groove wall 28. Additionally, the width of the front portion of groove protrusion 37 is just slightly less than the front portion of the width of the inner space between the two side portions of handle 41 of corralling utensil 40. Therefore when corralling utensil 40 is placed into groove 26 and pushed down into it, corralling utensil 44 is mostly centered within the cutting board automatically. The edges of groove protrusion 37 may be rounded and/or beveled for easier insertion of corralling utensil 40. Groove protrusion 37 may serve as the sole means of temporarily securing corralling utensil 40 to cutting board 20, whereby cutting board 20 may not necessarily need or have a delineated front groove wall 30 and/or back groove wall 28 to temporarily secure corralling utensil 40 to cutting board 20. In that case corralling utensil is secured to cutting board 20 via pressure fit or other means onto groove protrusion 37.

FIG. 3A shows corralling utensil 40, which is comprised of a mostly vertical retaining wall 44 that is horizontally bent inward, from a top view, here creating a concave shape, with a handle 41 attached to the opposite, convex side. The top and bottom of corralling utensil 40 are mostly flat, but may have beveled or rounded edges, and the top edge may be made not flat, if desired. Handle 41 has a handgrip 42 which is generally parallel to retaining wall 44. Handgrip 42 allows the user to use corralling utensil 40 without their fingers touching any cut food. FIGS. 3A and 3B, the latter showing a side view of corralling utensil 40, show handgrip 42 with an optional protuberance 47 formed longitudinally on its outer surface, which helps to facilitate more secure gripping of handgrip 42. This is especially helpful if a user's fingers are covered in slippery food residue during food preparation. Protuberance 47 may continue around the entire handle 41, if desired. Additionally, protuberance 47 may be textured or otherwise made to facilitate a better grip on it, for example by being over-molded with materials that provide better gripping means, or by engraving a logo, for example, in it. Alternatively, there may instead be a recess in handgrip 42 that facilitates better gripping on handle 41, or there may be both recesses and protuberances.

Protuberance 47 on utensil 40 may take various forms, and extends outward from handgrip 42. Here it is shown as mostly oval, with rounded edges and a mostly flat front, but it may be shaped in many other ways, and multiple smaller protuberances may be used instead of one larger one. Protuberance 47 can be provided in many ways, for example it may be formed as part of handgrip 42, or it may be made as a separate piece and attached to handgrip 42. It may be made of the same material as corralling utensil 40, or another material that may be more compressible, such as rubber or a plastic elastomer. It may have letters or other designs engraved in it to provide extra friction, and may protrude by various lengths.

Protuberance 47 provides several benefits. For example, it can provide an area for better gripping of handle 41. This benefit, as well as the easy lifting of corralling utensil 40 out of groove 26, may be further promoted by providing other means for facilitating the gripping of handle 41, as described above. Protuberance 47 may provide easier insertion and more secure storage of corralling utensil 40 within groove 26, depending on its protrusion distance, the material it is made from, and the design of cutting board 20. Since protuberance 47 is rounded at its edges, it will easily slide into groove 26 when corralling utensil 40 is pushed downwards into groove 26, as described below. Protuberance 47 may have beveled edges instead of rounded ones, which would provide similar benefit. Because protuberance 47 extends outward from handgrip 42, it will contact back groove wall 28 and create friction which secures corralling utensil 40 in groove 26. More friction, and therefore more secure storage will be created if protuberance 47 is made of a material that will create more friction, such as rubber or plastic elastomer, and/or is substantially textured, and/or has letters or other designs engraved within it, etc.

FIG. 3C shows a top view of corralling device 40 showing retaining wall 44 which is bent inward into a concave curve to facilitate a snug fit of corralling utensil 40 within groove 26. The curve of retaining wall 44 generally matches the corresponding curve of front groove wall 30, becoming gradually more concave as it moves outwards towards its outer ends, delineated as the arms 46 of retaining wall 44, whereby the curve of retaining wall 44 beyond handle 41 has a higher curvature than the corresponding outer curve 30A of front groove wall 30. Arms 46 constitute part of retaining wall 44. When corralling utensil 40 is inserted into groove 26, the flexibility of arms 46 cause them to elastically bend backward, as shown in FIG. 3E. The concavity of retaining wall 44 forms a gathering area 48 that facilitates the gathering, forming of piles, and moving of cut food as corralling utensil 40 is pushed along a surface with cut food on it. FIG. 4B shows a side view of corralling utensil 40 inserted into groove 26 of cutting board 20. If groove protrusion 37 serves as the sole means of temporarily securing corralling utensil 40 to cutting board 20, it is not necessary for arms 46 to bend back, or to even have delineated arms, since corralling utensil 40 is secured to cutting board 20 via pressure fit or other means onto groove protrusion 37.

FIGS. 3C and 3D show top views of corralling device 40 showing the placement and configuration of one option for compression means, shown here as hinges 45. Hinges 45 here are mostly vertical “living hinges” which are easily made in an injection molded part. The two side hinges 45 are standard living hinges, with cutouts on opposite sides of each hinge. Although the hinge 45 on retaining wall 44 may also have cutouts on each side, preferably the front hinge 45 only has a cutout on the back portion of retaining wall 44. This is to prevent food from getting stuck in a hinge that would otherwise be cutout on the front side of retaining wall 44. Alternatively, corralling utensil 40 may be made with only one hinge, on retaining wall 44, or with no hinge on retaining wall 44 but with hinges on handle 41. There may also be multiple hinges on retaining wall and/or handle 41.

The placement of the hinges on handle 41, as shown in FIGS. 3C and 3D, may be specifically located in order to limit the distance that the middle part of retaining wall 44 may be compressed inwards towards handgrip 42. The locations shown here in the drawings are the preferred locations, where hinges 45 on handle 41 are located approximately ⅓ the distance between retaining wall 44 and handgrip 42, from retaining wall 44. Hinge 45 is approximately center on retaining wall 44. The width and depth of hinges 45 can also limit the distance that retaining wall 44 is compressed. The wider the hinge 45, the more distance of compression is allowed.

The purpose of hinges 45 are to facilitate easier compressing of retaining wall 44. Such compression of the middle portion of retaining wall 44 also brings together the outer portions of retaining wall 44, and therefore also arms 46. This results in gathering area 48 being made more narrow, which allows the user to more easily and accurately guide food into a small container, as further described in the operation section.

Corralling utensil 40 should be made of a material that possesses elastic and flexible properties, although this is not necessary depending on the means of compression. I presently prefer it to be injection molded in a plastic that is safe for use with food products and able to be safely washed without affecting the integrity of the device, such as virgin polypropylene. It can be made in other ways with other materials, for example with flat stainless spring steel cut out from a pattern and configured to shape. Corralling utensil 40 may have various means of compression, including manufacturing the device of a flexible material, whereby corralling utensil 40 may not have other means of compression such as living hinges 45 yet still be effective in its stated purpose herein, allowing a user to focus food into a small container.

The size, shape, and configuration of corralling utensil 40 may vary, depending on factors such as intended use, intended users, the size and thickness of cutting board 20, the type and amount of food it will be used with, as well as manufacturing and aesthetic considerations. Wall thickness of corralling utensil 40 may vary, but should maintain sufficient integrity while providing enough elasticity and flexibility to facilitate the insertion, secure storage of, and removal of corralling utensil 40 to and from cutting board 20. Corralling utensil 40 may rise above cutting board 20 when stored in groove 26, as shown in FIG. 4B, or the top of corralling utensil 40 may be flush with or lower than the top surface of cutting board 20. Preferably the length of corralling utensil 40 should approximate the width of cutting board 20, but may be longer or shorter. The size, shape, configuration, and thickness of cutting board 20 may also vary, for example handhold 23 may be more or less thick than the rest of the board, the bottom surface of handhold 23 may be raised, and the top surface of handhold 23 may be lower than cutting surface 21.

Cutting Board 20 is made of a mostly rigid material. It may be made of wood or plastic such as high-density polyethylene (HDPE) that is cut to form on a computer numerical controlled (CNC) machine. A lightweight wood, or light core HDPE, or similar lightweight material may be used, and/or the bottom of the board may be hollowed-out, to decrease the weight of the board and create a recessed cutting surface for the preparation of juicy foods, whereby the juices from these foods will be captured within this recessed area. If the board is injection molded, a rigid, food-grade plastic should be used, such as virgin polypropylene, HDPE, or ABS. To increase the strength of the board, a rigid material may be attached on or inserted into parts of the board. For example, a flat piece of steel or reinforced fibers may be inserted into a corresponding space formed under groove 26 to provide more strength and rigidity to that area.

FIG. 6B shows a design of cutting board 20 which may be easily made through the process of injection molding. A recessed bottom cutting surface 38 provides a cutting area surrounded on three sides by outer board wall 31, extending along the perimeter of bottom cutting surface 38, except for at the front end 24, whereby cut food 60 and any juices resulting from cutting food remain inside this cutting area until removed, as shown in FIG. 6B. Bottom cutting surface 38 may be sloped so that juices flow down and backwards towards front groove wall 30 when bottom cutting surface 38 is facing upwards for use, after which the user may easily pour the juices out. Bottom cutting surface 38 may also have grooves, indents, or other means to help catch juices. Cutting surface 21 and/or bottom cutting surface 38 may be smooth to aid the gathering and moving of food across the surfaces, or may be pebbled, textured, or otherwise made to help keep food in place there during the cutting process, or they may be a combination of smooth and textured to provide the benefits of each in a particular area of the surface. Outer board wall 31 may protrude from only one side, two sides, or the entire perimeter of board 20.

These and the other methods described herein for temporarily securing corralling utensil 40 on, in, or to cutting board 20 may be used by themselves or in conjunction with any other method described, as well as with any other appropriate method, such as adding texture or horizontal ridges to portions of utensil 40.

### OPERATION

### Preferred Embodiment—FIGS. 4A-6D

In operation one uses the corralling utensil 40 by grasping it, typically on handle 41 and/or handgrip 42 and/or part of retaining wall 44, and pushing corralling utensil 40 generally forward along the surface of a cutting board or other surface so that cut food 60 thereon gathers substantially within gathering area 48, whereby cut food 60 can then be efficiently moved around or off the cutting board or other surface by continuing the forward movement of corralling utensil 40, as shown in FIG. 5B.

As shown in FIGS. 4A and 4B, side views of the preferred embodiment, when using corralling utensil 40 with associated cutting board 20, the user first removably secures corralling utensil 40 in groove 26 on cutting board 20 by pressing corralling utensil 40 forward with the front angled downward into groove 26, as indicated by the arrow, which will cause arms 46 to flexibly bend backward as they are pushed against outer front groove wall 30A. As corralling utensil 40 is pushed forward into groove 26, the user gradually pushes generally downward on handle 41 as shown in FIG. 4B and indicated by the arrow, until corralling utensil 40 rests mostly flat inside groove 26. The user then releases corralling utensil 40, and the tension from the flexing of arms 46 presses corralling utensil 40 backward so that handgrip 42 is pressed firmly back against back groove wall 28, thereby tensionally and frictionally holding corralling utensil 40 firmly but removably in place within groove 26. Optional radius 27 on the top edge of back groove wall 28 will facilitate easier placement of corralling utensil 40 into groove 26 by making it easier to gradually push handle 41 down into groove 26. Other methods of insertion may be used, depending on user preference, for example by first inserting one side of corralling utensil 40 into groove 26, then pressing down on the other side, to secure corralling utensil 40 in place. Raised groove protrusion 37 assists the user in placing corralling utensil 40 within groove 26 and helps to self-center corralling utensil 40 within groove 26.

The user then proceeds to use cutting board 20 as they normally would, using a knife or other sharp instrument to cut articles of food on cutting surface 21 of board 20, typically resulting in cut food 60 scattered on cutting surface 21, as shown in FIG. 5A. When the user desires to move cut food 60 around or off cutting board 20, for example to transfer the food into a sink, colander, pot, dish, storage container, or other location, the user picks up cutting board 20 by its handhold 23, or at any other convenient location, and brings it into proximity of the location for transfer of the food, here shown as container 64. Corralling utensil 40 is then removed from groove 26 by lifting it upwards or pulling it out sideways. The sliced, chopped, or cut food 60 is then guided around and transferred from cutting board 20 by pushing corralling utensil 40 generally forward along the surface 21 of cutting board 20 so that cut food 60 substantially gathers within gathering area 48 of corralling utensil 40. Corralling utensil 40 is then pushed further along surface 21 towards the end or a side of cutting board 20, whereby cut food 60 is pushed off cutting board 20 into container 64, as shown in FIG. 5B. When the user is finished, they may reinsert corralling utensil 40 into cutting board 20, as described above, for later use. When the user is finished with their food preparation, cutting board 20 and corralling utensil 40 can be cleaned by hand or in a dishwasher, depending on the materials used to make each part, and may be stored together or separately.

The user may rotate corralling utensil 40 while moving it generally forward, which will help focus the cut food 60 for more accurate moving, for example if pushing cut food 60 into a small container 64, as shown in top view FIG. 5C. By containing cut food 60 within corralling area 48, the present invention facilitates faster, easier, safer, and more accurate movement of cut food around and off cutting board 20. The user may also compress retaining wall 44 by pressing inwards on retaining wall 44, towards handgrip 42, with their fingers while their thumb presses on handgrip 42, towards retaining wall 44. Such compression of the middle portion of retaining wall 44 brings closer together the outer portions of retaining wall 44, and therefore also arms 46. This results in gathering area 48 being made more narrow. A more narrow gathering area 48 allows the user to more easily and accurately guide food into a small container, as shown in FIGS. 5D and 5E. The user may both rotate and compress corralling utensil 40 at the same time, if desired.

In the preferred embodiment, both sides of cutting board 20 may be used, and both sides of corralling utensil 40 may be used. Corralling utensil 40 may be picked-up and used from wherever it happens to be placed down, for example on a counter or table, and may be used without cutting board 20, on other surfaces such as butcher blocks, chopping mats, and other cutting boards. Corralling utensil 40 can also be used to push food onto a knife in order to carry the food to another location, and may be removed from cutting board 20 while cutting or otherwise preparing food.

The injection-molded board shown in FIG. 6B is used in a similar manner. FIG. 6B shows the present invention 10 being used upside down, showing how the user may insert corralling utensil 40 into the area formed on and around surface 38 after food has been cut there, then push corralling utensil 40 generally forward in the direction of the arrow to gather and guide cut food 60 along surface 38 and off front end 24. Using the present invention in this way provides the benefit of further preventing cut food 60 from falling off board 20, because the food is contained within the cutting area until removed. Cutting board 20 shown in FIG. 6B has a handhold 23 whose bottom surface is raised, so that a user may more easily slide their fingers underneath handhold 23 when lifting cutting board 20. Cutting board 20 may be used upside down so that recessed bottom cutting surface 38 may be used in a similar fashion as described above, as shown in FIG. 6B, which shows how outer board wall 31 on either side of the recessed cutting surface helps to corral food 60 along the length of board 20 by in essence becoming an extension of arm 46, thereby creating a larger gathering area 48.

The above description should not be construed as the invention's only configuration, form, or use. There are various possibilities with regard to the corralling utensil, the cutting board, their use alone and together, as well as their interaction with each other and the user, while still generally maintaining the advantages of the preferred embodiment. For example, corralling utensil 40 can be made without a handle, or with a differently shaped handle, and may have any variation of curvature, from flat to rounded. It can be used on its own on surfaces other than cutting board 20, and be made with arms 46 that do not flex. Cutting board 20 can be made in many shapes, configurations, and sizes, and be made with differently shaped and configured grooves in various locations on the board.

Referring now to FIGS. 6C-8B, alternative embodiments of the present invention will be described in detail. These embodiments are substantially similar to the preferred embodiment disclosed above, with slight modifications as described.

### DESCRIPTION

### Alternative Embodiment A—FIGS. 6C-6D

FIG. 6C shows Alternate Embodiment A 10-A of the present invention which is similar to the device shown in FIG. 6B, with a differently shaped corralling utensil 40A which is mostly flat, whereby handle 41 comprises a protrusion extending from retaining wall 44. Recessed bottom cutting surface 38 is facing upwards in this version, so as to become the top cutting surface. Corralling utensil 40A fits into groove 26 and is removably secured there by pressure fit. This is accomplished by one or both of the following methods, the first being the top of handle 41 and the bottom of retaining wall 44 create friction against back groove wall 28 and front groove wall 30, respectively. The second method is that the area of corralling utensil 40A between handle 41 and retaining wall 44 fits snugly yet removably over groove protrusion 37.

As can be seen in FIGS. 6C and 6D, retaining wall 44 and arms 46 can be made mostly straight and/or mostly flat and still prove effective for the intended use as described herein. Because outer board wall 31 essentially becomes arm 46 when recessed bottom cutting surface 38 is being used, a mostly straight and flat corralling utensil 40A may be used, whereby a gathering area 48 is formed between retaining wall 44 and outer board wall 31. The handle 41 of corralling utensil 40A may be made so that it is wider than the delineation of groove 26, so that corralling utensil 40A is easier to remove from board 20A.

### OPERATION

### Alternative Embodiment A—FIG. 6D

Alternative Embodiment-A 10-A works similarly to the preferred embodiment of the present invention, as described above, the user grasping corralling utensil 40A by handle 41 and using corralling utensil 40A to corral and move food along surface 38. As shown in FIG. 6D, the outer board walls 31 of cutting board 20 act in concert with retaining wall 44 to form a gathering area 48. The user inserts corralling utensil 40A into the area formed on and around surface 38 after food has been cut there, then pushes corralling utensil 40A generally forward in the direction of the arrow to gather and guide cut food 60 along surface 38 and off front end 24.

If groove protrusion 37 serves as the sole means of temporarily securing corralling utensil 40 to cutting board 20, corralling utensil 40 is secured to cutting board 20 by pressing the area between handle 41 and retaining wall 44 of corralling utensil 40 onto groove protrusion 37.

### DESCRIPTION

### Alternative Embodiment B—FIGS. 7A-7F

FIGS. 7A-7F show Alternative Embodiment B 10-B constructed in accordance with the present invention, where board 20B does not have the handhold as described in the preferred embodiment. Groove 26 may accommodate utensil 40 as described above, or be designed to accommodate corralling utensils 40 that may have different shapes and configurations, by, for example, providing two separate back groove walls 28. Corralling utensils 40-B shown here are made with no delineated handle 41, whereby handle 41 and retaining wall 44 are essentially the same part, therefore the user grasps a part of retaining wall 44 in order to use the device. FIG. 7A shows board 20B accommodating a corralling utensil 40B with an extended retaining wall 44 which the user may grasp during use.

Cutting board 20B in this embodiment has a gripping recess 39 on each side for the user to slide one or both hands under to better grasp the board during use. Other means to facilitate a good grip on cutting board 20 may be provided, for example optional thumb grooves 39A may be placed above the gripping recesses 39 for the placement of the user's thumb while holding the board there, as shown in FIGS. 7A and 7B, and a ledge may be provided that protrudes from a part of cutting board 20B that the user may grasp during use in place of a handle. The ledge may also comprise means for the removable storage of corralling utensil 40. Also shown here is how back groove wall 28 and/or front groove wall 30, or portions thereof, may tilt outwards, be beveled, textured, or otherwise shaped or provided with means to help facilitate the easy and secure insertion and storage of corralling utensil 40B within groove 26. For example, back groove wall 28 may rise above cutting surface 21, which makes it easier to insert corralling utensil into groove 26. Additionally, in this embodiment, corralling utensil 40B may be made so that arms 46 do not necessarily bend backwards; instead retaining wall 44 and arms 46 are made to follow the same general curvature as front groove wall 30, in which case gravity and/or friction holds corralling utensil 40B in place in groove 26. According to this embodiment of the present invention, cutting board 20B is substantially rectangular in shape. However, cutting board 20B in this and any other embodiment can be any organic or geometric shape, such as hexagonal, octagonal, circular, oval, triangular, rhomboidal, etc.

FIGS. 7C-7F show examples of other shapes that corralling utensil 40B may take. FIG. 7E shows a corralling utensil 40B that does not have a living hinge 45. If made of a flexible material, it may still be bent by the user, as shown in FIG. 7F.

### OPERATION

### Alternative Embodiment-B—FIGS. 7B, 7D and 7F

Alternative Embodiment-B 10B works similarly to the preferred embodiment of the present invention, as described above, except the user would grasp board 20B along the perimeter of the board during use, for example at gripping recess 39, where the user's thumb may rest in thumb groove 39A. Corralling utensil 40B is placed into groove 26 by placing one arm 46 of utensil 40B into one end of groove 26, then bending corralling utensil 40B inward to place the other arm 46 into the other end of groove 26, and pressing corralling utensil 40B downwards until it is secured therein. If retaining wall 44 and arms 46 have the same curvature as front groove wall 30, corralling utensil 408 is simply pushed down into groove 26. To remove corralling utensil 40B, the user grasps handle 41, or retaining wall 44, arm 46, or anywhere else on corralling utensil 40B depending on the design of corralling utensil 40B and what feels comfortable to the user, then pulls corralling utensil 40B upwards out of groove 26 and uses it as described above in the preferred embodiment. FIG. 7B shows embodiment B 10B in use, with utensil 40B gathering and moving cut food 60.

As shown in FIGS. 7D and 7F, the user may compress retaining wall 44, for example by placing their thumb and middle finger behind retaining wall 44 while keeping their index finger in front and substantially in the middle of retaining wall 44. By squeezing their fingers together, the outer portions of retaining wall 44, and therefore also arms 46 are brought closer together, as shown in FIGS. 7D and 7F. This results in gathering area 48 being made more narrow. A more narrow gathering area 48 allows the user to more easily and accurately guide food into a small container.

### DESCRIPTION

### Alternative Embodiment C—FIG. 8A

FIG. 8A shows a perspective view of Alternative Corralling Utensil-C 40C constructed in accordance with the present invention, showing a corralling utensil 40C with a compression protrusion 50 extending from one side of retaining wall 44. Compression protrusion 50 provides a place for the user to place a finger on during compression, so that their finger does not touch food that is being corralled within gathering area 48. There may be more than one compression protrusion 50 located on other places on retaining wall 44 or elsewhere on corralling utensil 40C. Compression protrusion 50 may be shaped and sized differently than shown here.

### OPERATION

### Alternative Embodiment C—FIG. 8A

Alternative Corralling Utensil-C 40C is used in a similar manner as the preferred embodiment, described above. However, when the user compresses Corralling Utensil-C 40C they place their finger on compression protrusion 50 and pull back on it in order to compress retaining wall 44.

### Description

### Alternative Embodiment D—FIG. 8B

FIG. 8B shows a perspective view of Alternative Corralling Utensil-D 40D constructed in accordance with the present invention, showing a corralling utensil 40D with a finger pull 52 extending back from retaining wall 44. Finger pull 52 provides a place for the user to place a finger in during compression, so that their finger does not touch food that is being corralled within gathering area 48. There may be more than one finger pull 52 located on other places on retaining wall 44 or elsewhere on corralling utensil 40D. Finger pull 52 may be shaped and sized differently than shown here,

### OPERATION

### Alternative Embodiment D—FIG. 8B

Alternative Corralling Utensil-D 40D is used in a similar manner as the preferred embodiment, described above. However, the user may compress Corralling Utensil-D 40D by placing their finger in finger pull 52 and pull back on it.

### ADVANTAGES

From the description above, a number of advantages of my corralling utensil and associated cutting board become evident:
(a) The present invention facilitates faster and easier food preparation by providing a device for accurate and efficient gathering and moving of piles of cut food around and off the cutting board and other surfaces. It allows users to aim and focus cut food into containers such as cooking pots, dishes, storage containers, etc. by rotating and/or compressing the corralling utensil while pushing it forward. This is especially advantageous when the container is smaller than the width of the cutting board.
(b) The present invention facilitates cleaner food preparation by helping to prevent pieces of cut food from inadvertently falling off a cutting surface onto the floor, stove, etc. when the user is moving food from a cutting surface to a container. It saves the user time and energy otherwise needed for cleaning up wayward food, it keeps the kitchen more sanitary, and it saves the user money through less food waste and need for cleaning materials, which also benefit the environment.
(c) The corralling utensil may be made so that it locks temporarily in a compressed position.
(d) The present invention allows the user to push food off the sides, front, back, or corners of a cutting board, it allows users to move a single pile when more than one is on the board, as well as move partial piles of food if desired. Juices and residue are also effectively pushed off the board. The corralling utensil may also act as a retaining wall and splash guard when inserted in the board;
(e) The present invention can be used effectively by right-handed and left-handed users. It is easy to use, easy to learn how to use, and is easily cleaned by hand or in a dishwasher, depending on the materials used for production of the various parts;
(f) The corralling utensil can be stored within the cutting board when not in use, thereby being less likely to get lost or misplaced, and is in a convenient location when needed for use, therefore providing fast access to it during food preparation.
(g) The corralling utensil can be sold without the cutting board for use on its own with other cutting boards and surfaces, for example with butcher blocks and chopping mats, or to clean-up food that has spilled on a table, counter, or floor. When cleaning-up food waste and other messes from a surface such as a counter, the user may use the corralling utensil to move the food waste, etc. off the surface onto the cutting board for easy transport to a disposal. This is even more advantageous if the cutting board has a recessed bottom surface that may be used for the collection of the food waste. The cutting board can also be used on its own, without the corralling utensil.

### CONCLUSION, RAMIFICATIONS, AND SCOPE

Accordingly the reader will see that, according to the present invention, I have provided a corralling utensil and associated cutting board that allows the user to cut food items as easily as usual, then accurately guide the piles of cut food around and off the cutting board. Furthermore, the present invention has the additional advantages that:
Various methods may be implemented to make the present invention and any embodiment thereof easier for the user to grip and use. For example, handgrip 42 and handhold 23 can be textured, ridged, grooved, coated, over-molded, filled-in, engraved, have finger indents, etc., and/or coated with various materials, such as rubber, plastic, or silicone, to improve the grip. Additionally, handgrip 42 and handhold 23 may be designed to be more ergonomic, or accommodate various sizes of fingers and hands, for example by making them thinner or rounder;
The corralling utensil can be made wholly or partially of various materials, such as plastic, wood, composites, rubber, glass, or metal. For example, the retaining wall 44 can be made of stainless steel, attached to a plastic handle 41;
The corralling utensil can be coated with PTFE or other non-stick coatings, as well as other coatings to provide various benefits, for example to make it slide more easily along surfaces. It can be made from a material that resists sticking, such as HDPE or polypropylene. The retaining wall can also be appropriately shaped, textured, or scalloped to reduce the likelihood of food sticking to it;
The corralling utensil may be sized and shaped in various ways, such as with a larger or smaller handle, shorter or longer retaining wall, etc. The top or bottom of the corralling utensil may be made not flat, for example it can be curved or have protrusions. The top or bottom may be textured, ridged, grooved, etc. to provide more scraping ability, which may be useful for cleaning surfaces. The corralling utensil may be made without a distinct handle, and still prove effective for its intended use, as may the cutting board;
The retaining wall 44 on the corralling utensil may be shaped in various ways, such as in a “V” shape, with areas of straight and/or curved sections, with tapered arms, or in a tighter or looser curve. A tighter curve would provide a tighter fit inside groove 26, and provide more focusing of food being moved. Other designs may be utilized to provide better food gathering and moving ability, for example the retaining wall and arms may, from a side view, have a vertically curved, concave, or angled shape;
The cutting board may have its top surface be mostly flat, with the bottom of the board not flat, for example being concave or hollowed out, or having “feet” or other extensions protruding from the bottom of the cutting board to provide anti-slip characteristics, elevate the cutting board above a countertop, and provide support for the cutting board during the cutting process. Similarly, parts of the board may be designed and/or textured in a manner that provides anti-slip characteristics. The top surface of handhold 23 may be lower than cutting surface 21, or tapered downward towards groove 26, to facilitate easier insertion of corralling utensil 40 in groove 26. The cutting board can be made wholly or partially of various materials, such as wood, metal, plastic, and/or silicone, for example with a wood cutting surface, a plastic handle and a metal groove;
Groove 26 may be made so that it holds the retaining wall and/or arms only, or only the handle, of the corralling utensil. The outer front groove wall 30A may be notched to catch the outer ends of the arms of the corralling utensil;
The cutting board may not have a groove, instead relying solely on a protrusion on the board to removably secure the corralling utensil thereto;
The corralling utensil can be temporarily held in place within groove 26 by means other than those described herein, for example with Velcro, suction cups, clips, or other means. The corralling utensil, groove, or cutting board may be designed so that the corralling utensil is more securely held in the groove, for example by utilizing a ball catch or other mechanical device;
The present invention can be used to corral things other than food, such as kitchen waste, hardware items such as nails, home items such as pills, and office items such as thumbtacks.
Finger placement on the corralling utensils described herein may vary depending on user preferences.
Arms 46 may not necessarily be defined separately from retaining wall 44. Arms 46 may extend farther than shown herein.
The corralling utensils shown herein can be used effectively and according to the present invention with or without the compression of retaining wall 44.

While the above description contains many specificities, these should not be construed as limitations on the scope of the invention, but as exemplifications of the presently preferred embodiments thereof. Many ramifications and variations are possible within the teachings of the invention. Thus the scope of the invention should be determined by the appended claims and their legal equivalents, not by the examples given.

What is claimed is:

1. A freely movable corralling utensil for gathering and moving items comprising:
(a) At least one retaining wall;
(b) Gripping means for grasping said corralling utensil;
(c) Said corralling utensil having means to change shape.

2. The corralling utensil of claim 1, wherein said means to change shape comprises at least one hinge.

3. The corralling utensil of claim 1, wherein said means to change shape comprises at least one portion of said corralling utensil having elastic properties.

4. The corralling utensil of claim 1, wherein said gripping means comprises a U-shaped handle attached to said retaining wall.

5. The corralling utensil of claim 1, wherein said gripping means comprises at least one protrusion extending from said retaining wall.

6. The corralling utensil of claim 1, wherein said retaining wall is mostly concave.

7. The corralling utensil of claim 1, further comprising an associated cutting board comprising at least one cutting surface for cutting articles thereon, said cutting board further comprising means for removably securing said corralling utensil thereon.

8. The cutting board of claim 7, wherein said means for removably securing said corralling utensil comprises at least one groove.

9. The cutting board of claim 7, wherein said means for removably securing said corralling utensil comprises at least one protrusion.

10. The cutting board of claim 7, further comprising a wall protruding from at least one side of said cutting board.

11. The corralling utensil of claim 1, wherein at least one portion of said corralling utensil comprises means for removably securing said corralling utensil to a cutting board.

12. The corralling utensil of claim 11, wherein said means for removably securing said corralling utensil to a cutting board comprises a hole formed within said corralling utensil.

13. A corralling utensil with associated cutting board, comprising:
(a) said corralling utensil comprising at least one retaining wall;
(b) said corralling utensil further comprising grasping means for holding and moving said corralling utensil;
(c) said corralling utensil comprising means to change shape;
(d) said cutting board comprising at least one surface for cutting articles thereon;
(e) whereby said corralling utensil may be moved upon said cutting board whereby items on said cutting board are substantially gathered, and may be transferred to another location.

14. The corralling utensil of claim 13, wherein said means to change shape comprises at least one living hinge.

15. The corralling utensil of claim 13, wherein said means to change shape comprises at least one portion of said corralling utensil having elastic properties.

16. The corralling utensil of claim 13, wherein said corralling utensil comprises securing means for removably securing said corralling utensil to said cutting board.

17. The cutting board of claim 13, further comprising a wall protruding from at least one side of said cutting board.

18. The cutting board of claim 13, wherein said cutting board further comprises means for removably securing said corralling utensil to said cutting board.

19. A method for gathering and moving one or more items on a surface, comprising:
a) providing said surface with said one or more items thereon;
b) providing a rotatable corralling utensil for said gathering and moving, said corralling utensil having at least one retaining wall, and said corralling utensil having means to change shape;
c) providing grasping means for holding and moving said corralling utensil;
d) holding said corralling utensil and moving said corralling utensil along said surface whereby said one or more items on said surface are substantially gathered and moved along said surface by said corralling utensil.

20. The method of claim 19, wherein said surface comprises a cutting board, said cutting board comprising at least one surface for cutting articles thereon, said cutting board further comprising securing means for removably storing said corralling utensil, and said corralling utensil further comprising means for removably securing said corralling utensil in, on, or to said cutting board.
